(19) United States
(12) Patent Application Publication
(10) Pub. No.: US 2013/0064284 A1
(43) Pub. Date: Mar. 14, 2013

(54) Encoder And Method Thereof For Encoding a Representation of a Picture of a Video Stream

(71) Applicants: Jonatan Samuelsson, Stockholm (SE); Rickard Sjöberg, Stockholm (SE)

(72) Inventors: Jonatan Samuelsson, Stockholm (SE); Rickard Sjöberg, Stockholm (SE)

(73) Assignee: TELEFONAKTIEBOLAGET L M ERICSSON (PUBL), Stockholm (SE)

(21) Appl. No.: 13/641,714

(22) PCT Filed: Jun. 26, 2012
(86) PCT No.: PCT/SE12/50712

§ 371 Date: Oct. 17, 2012

Related U.S. Application Data
(60) Provisional application No. 61/508,179, filed on Jul. 15, 2011.

(51) Int. Cl. H04N 7/26

(52) U.S. Cl. 375/240.01; 375/E07.026

(57) ABSTRACT

The embodiments of the present invention relates to an encoder and a method thereof for management of self contained pictures referred to as CRA pictures, wherein the CRA picture is identified as a random access point. The CRA pictures are assigned a lowest layer identity.

### BACKGROUND

H.264, also referred to as Moving Picture Experts Group-4 (MPEG-4) Advanced Video Coding (AVC), is the state of the art video coding standard. It consists of a block based hybrid video coding scheme that exploits temporal and spatial prediction.

High Efficiency Video Coding (HEVC) is a new video coding standard currently being developed in Joint Collaborative Team-Video Coding (JCT-VC). JCT-VC is a collaborative project between MPEG and International Telecommunication Union Telecommunication standardization sector (ITU-T). Currently, a Working Draft (WD) is defined that includes large macroblocks (abbreviated LCUs for Largest Coding Units) and a number of other new tools and is more efficient than H.264/AVC.

In video transmission, a decoder of a receiver receives a bit stream representing pictures, i.e. video data packets of compressed data. The compressed data comprises payload and control information. The control information comprises e.g. information of which reference pictures should be stored in a reference picture buffer. This information is a relative reference to previously received pictures. Further, the decoder decodes the received bit stream and displays the decoded picture. In addition, the decoded pictures are stored in a reference picture buffer according to the control information. These stored reference pictures are used by the decoder when decoding subsequent pictures.

A simplified flow chart of the scheme performed at the receiver as it is designed in H.264/AVC is shown in FIG. 1. Before the actual decoding of a picture, the frame_num in the slice header is parsed 100 to detect possible gap in frame_num 110 if Sequence Parameter Set (SPS) syntax element gaps_inframe_num_value_allowed_flag is 1. The frame_num indicates the decoding order. If a gap in frame_num is detected, “non-existing” frames are created 120, 130 and inserted into the reference picture buffer, also referred to as Decoded Picture Buffer (DPB). A sliding window process and a bumping process are then applied.

Regardless of whether there was a gap in frame_num or not the next step is the actual decoding 160 of the current picture. If the slice headers of the picture contain Memory Management Control Operations (MMCO) commands 170, adaptive memory control process is applied 180 after decoding of the picture to obtain relative reference to the pictures to be stored in the reference picture buffer; otherwise a sliding window process is applied 190 to obtain relative reference to the pictures to be stored in the reference picture buffer. As a final step, the “bumping” process is applied 200 to deliver the pictures in correct order.

HEVC also defines a temporal_id for each picture, corresponding to the temporal layer the picture belongs to. A picture A with temporal_id tIdA can not use a picture B with temporal_id tIdB for reference if tIdB is higher than tIdA.

Further, HEVC contains the concept of temporal layer switching points. The temporal layer switching point is a picture in the encoded bitstream at which it is possible to start decoding pictures from higher temporal layers even though pictures from the higher temporal layers preceding the switching point has not been decoded. This is realized in HEVC by marking all pictures in higher temporal layers as “unused for prediction” when the temporal layer switching point has been decoded. Thus the temporal layer switching point is a guarantee from the encoder to the decoder that the encoder will send control information to mark higher pictures as unused for prediction. There is no decoder action tied to the temporal layer switching point.

The HEVC working draft contains clean random access (CRA) access unit, which is an access unit in which the coded picture is a CRA picture. It should be noted that CRA pictures can also be referred to as Clean Decoding Refresh (CDR) pictures or Deferred Decoding Refresh (DDR) pictures. Further, clean random access (CRA) picture is a self-contained coded picture using intra prediction for all blocks, whereby the CRA pictures contains enough information to be decoded without relying on reference pictures. The CRA picture is a new picture type introduced in HEVC with corresponding Network Adaptation Layer (NAL) unit type. The CRA picture is a random access point which is used to indicate a point in the bitstream at which a decoder can start to correctly decode the CRA picture and all pictures that follow the CRA picture in both decoding order and display order.

When the pictures are encoded as CRA pictures, it is proposed that no normative decoder action takes place in response to the detection of a picture being a CRA picture. As mentioned above, the temporal layer switching point is a guarantee from the encoder to the decoder that the encoder will send control information to mark higher pictures as unused for prediction.

Each CRA has its own NAL unit type and each NAL unit is associated with a layer identifier, such as a temporal identifier. NAL units with a layer identity A may not use NAL units with layer identity B for reference when A<B.

### SUMMARY

It should be noted that in this context display order is indicated by the variable Picture Order Count (POC) handling the value related to the display order and decoding order is indicated by the variable decoding order. If a CRA picture A is encoded by an encoder with frame_num fA, POC pA and temporal_id tIdA, the decoder shall mark all reference pictures except A “unused for reference” before decoding the first picture B with frame_num fB>fA and POC pB>pA. When the first picture C that fulfills the requirement that its temporal_id tIdC<tIdA and frame_num fC>fA and POC pC>pA is decoded, there will be no reference pictures available that it can use for reference. This is because A can not be used since it has a higher temporal_id than C and all other pictures with temporal_id lower than or equal to tIdC will be marked “unused for prediction” before B is decoded. B in this example might be the same picture as C or another picture with temporal_id higher than or equal to tIdA.

Since C will have no pictures available for prediction it must be encoded using only intra-prediction and will thus be very costly.

It would therefore be desired to solve the above stated problem.

The above stated problem is solved by putting a requirement on the bitstream that CRA pictures or corresponding self-contained pictures identifiable as random access points must belong to a lowest layer. Self-contained pictures imply in this specification pictures that can be decoded without using reference pictures. However, the self-contained picture is not required to contain all information for decoding. The self-contained picture can also be referred to as intra picture.

For a temporal layered structure, this means that any NAL unit with NAL unit type set to CDR NAL may have temporal_id=0.

Hence according to a first aspect of embodiments of the present invention, a method of encoding pictures of a video stream is provided. In said method, a layer identifier is assigned to pictures being self-contained and identifiable as a type of random access point pictures for which all coded pictures that follow that type of random access point picture both in decoding order and output order are not allowed to use inter prediction from any picture that precedes the random access point picture of said type in output order, wherein the layer identifier is set to a lowest layer identity.

Hence according to a second aspect of embodiments of the present invention, an encoder for encoding pictures of a video stream is provided. Said encoder comprises a processor for assigning a layer identifier to pictures being self-contained and identifiable as a type of random access point pictures for which all coded pictures that follow that type of random access point picture both in decoding order and output order are not allowed to use inter prediction from any picture that precedes the random access point picture of said type in output order, wherein the processor is configured to set the layer identifier is set to a lowest layer identity.

An advantage with the embodiments of the present invention is that they put a requirement on the bitstream that makes usage of CDR pictures clearer. The embodiments can also reduce the bitrate required for encoding a video sequence since no other pictures following the CDR pictures need to be encoded using only intra-prediction, since there will be reference pictures available for prediction.

### BRIEF DESCRIPTION OF THE DRAWINGS

FIG. 1 is a simplified flow chart of the H.264/AVC reference buffer scheme according to prior art;

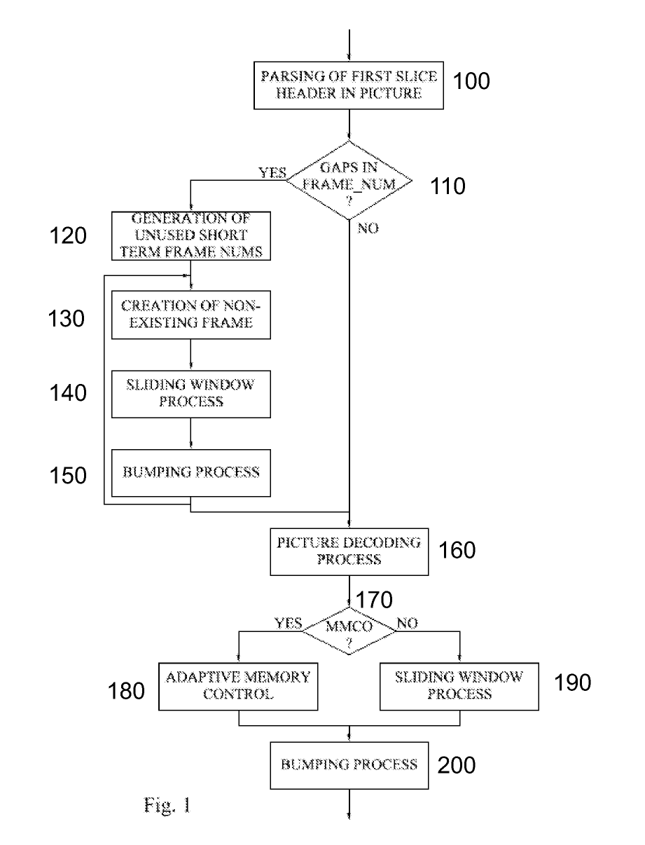

FIG. 2 is an example of a coding structure with two temporal layers according to prior art;

FIG. 3 is a flowchart of a method performed by an encoder according to an embodiment;

FIG. 4 is an encoded representation of a picture according to an embodiment;

FIG. 5 illustrates schematically an encoder according to embodiments of the present invention;

### DETAILED DESCRIPTION

Throughout the drawings, the same reference numbers are used for similar or corresponding elements.

The present embodiments generally relate to encoding of pictures, also referred to as frames in the art, of a video stream. In particular, the embodiments relate to management of self contained pictures containing only I slices referred to as CRA pictures. The CRA picture is identified as a type of random access point pictures for which all coded pictures that follow that type of random access point picture both in decoding order and output order are not allowed to use inter prediction from any picture that precedes the random access point picture of that type in output order.

Video encoding, such as represented by H.264/MPEG-4 AVC and HEVC, utilizes reference pictures as predictions or references for the encoding and decoding of pixel data of a current picture. This is generally referred to as inter coding where a picture is encoded and decoded relative to such reference pictures. In order to be able to decode an encoded picture, the decoder thereby has to know which reference pictures to use for the current encoded picture and has to have access to these reference pictures.

Video encoding and decoding can be done in a scalable or layered manner. For instance, temporal scalability is supported in H.264/MPEG-4 AVC and Scalable Video Coding (SVC) through the definition of subsequences and usage of temporal_id in SVC and insertion of “non-existing” frames. However, in order to support temporal scalability, the pictures in the higher temporal layers are restricted when it comes to usage of Memory management control operations (MMCO). The encoder is responsible of making sure that the MMCOs in one temporal layer does not affect pictures of lower temporal layers differently compared to if the temporal layer is dropped and “non-existing” pictures are inserted and sliding window process is applied.

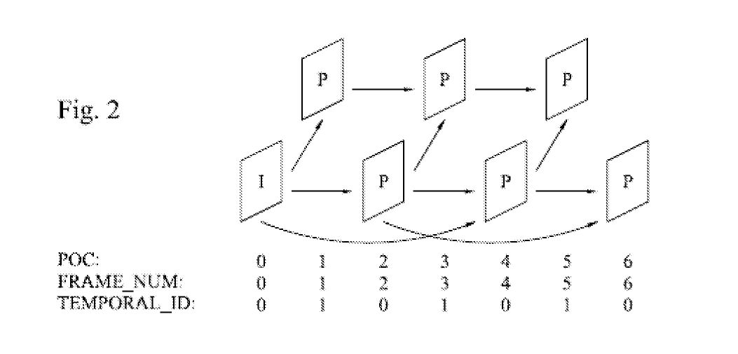

This imposes restrictions on the encoder in selection of coding structure and reference picture usage. For instance, consider the example in FIG. 2. Assume that the maximum number of reference frames in the reference picture buffer (max_num_ref_frames) is three even though each picture only uses two reference pictures for inter prediction. The reason is that each picture must hold one extra picture from the other temporal layer that will be used for inter prediction by the next picture.

In order to have picture POC=0 and picture POC=2 available when decoding picture POC=4, picture POC=3 must have an explicit reference picture marking command marking picture 1 as unavailable.

However, if temporal layer 1 is removed (for example by a network node) there will be gaps in frame_num for all odd numbered pictures. “Non-existing” pictures will be created for these pictures and sliding window process will be applied. That will result in having the “non-existing” picture POC=3 marking picture POC=1 as unavailable. Thus, it will not be available for prediction when picture POC=4 is decoded. Since the encoder cannot make the decoding process be the same for the two cases; when all pictures are decoded and when only the lowest layer is decoded; the coding structure example in FIG. 2 cannot be used for temporal scalability according to prior art.

In the case of a scalable video stream with the pictures grouped into multiple layers, picture identifier and temporal layer information are provided identifying a layer of the multiple layers to which the reference picture belongs. A reference picture set, also referred to as buffer description information is then generated based on the at least one picture identifier and the temporal layer information of the reference pictures. This means that the reference picture set defines the at least one picture identifier and temporal layer information of the reference pictures.

For instance, temporal layer information, such as temporal_id, is included for each picture in a buffer description, containing the reference picture set, is signaled using ceil(log 2(max_temporal_layers_minus1)) bits for signaling of the temporal id. Temporal scalability is merely an example of multi-layer video to which the embodiments can be applied. Other types include multi-view video where each picture has a picture identifier and a view identifier.

Further, as mentioned previously the current definition of a CRA picture does not contain restrictions or rules for temporal_id.

If a CRA picture A is encoded by an encoder with frame num fA, POC pA and temporal_id tIdA the encoder signals to the decoder that the decoder shall mark all reference pictures except A “unused for reference” before decoding the first picture B with frame num fB>fA and POC pB>pA. When the first picture C that fulfills the requirement that its temporal_id tIdC<tIdA and frame_num fC>fA and POC pC>pA is decoded, there will be no reference pictures available that it can use for reference. This is because A can not be used since it has a higher temporal_id than C and all other pictures with temporal_id lower than or equal to tIdC will be marked “unused for prediction” before B is decoded. (B in this example might be the same picture as C or another picture with temporal_id higher than or equal to tIdA)

Since C will have no pictures available for prediction it must be encoded using only intra-prediction and will thus be very costly.

The above stated problem is solved by putting a requirement on the bitstream that CRA pictures must belong to a lowest layer.

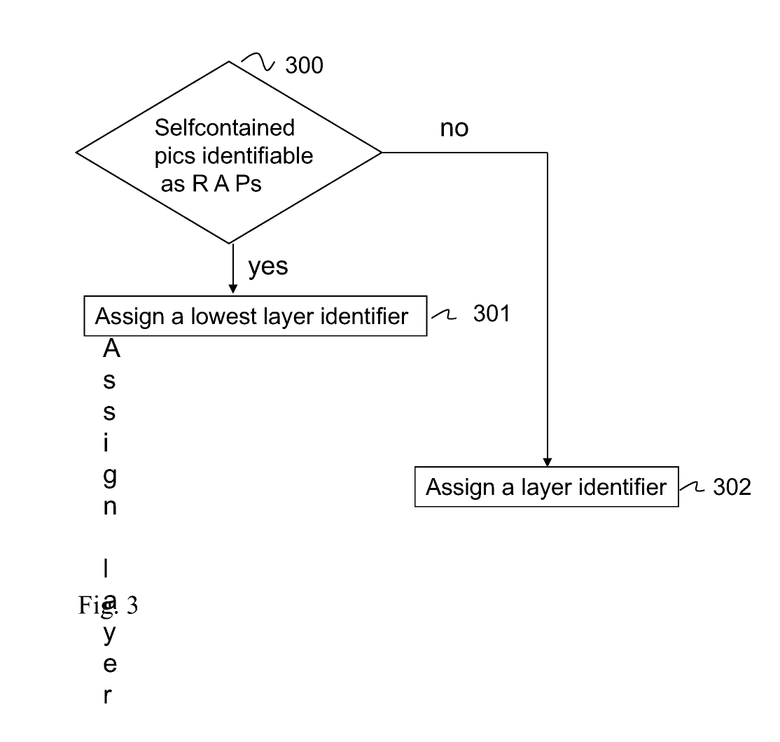

Hence, a method performed by an encoder is provided as illustrated in the flowchart of FIG. 3. In the method, pictures of a video stream is encoded. If the pictures being self-contained and identifiable as a type of random access point pictures (RAP) for which all coded pictures that follow that type of random access point picture both in decoding order and output order are not allowed to use inter prediction from any picture that precedes the random access point picture of said type in output order 300, a layer identifier is assigned 301 to the pictures, wherein the layer identifier is set to a lowest layer identity, e.g. 0. The other pictures can be assigned 302 a layer identifier according to other rules such that layers can be removed and still being able to decode the pictures. These other rules are not within the scope of the embodiments of the present invention.

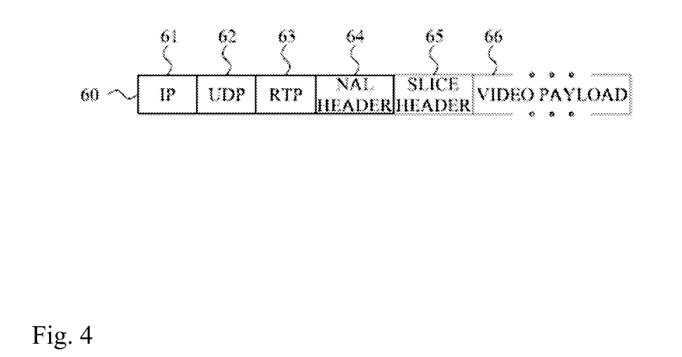

Information indicating whether pictures are coded as CRA pictures may be carried in a NAL unit header as illustrated in FIG. 4 and the layer identifier information may also be carried in the NAL unit header. The NAL unit header is one type of control information which is transmitted from the encoder to the decoder. Thus FIG. 4 illustrates an example of an encoded representation 60 of a picture. The encoded representation 60 comprises video payload data that represents the encoded pixel data of the pixel blocks in a slice. The encoded representation 60 also comprises a slice header 65 carrying control information. The slice header 65 forms together with the video payload and a Network Abstraction Layer (NAL) header 64 a NAL unit that is the entity that is output from an encoder. To this NAL unit additional headers, such as Real-time Transport Protocol (RTP) header 63, User Datagram Protocol (UDP) header 62 and Internet Protocol (IP) header 61, can be added to form a data packet that can be transmitted from the encoder to the decoder.

The CRA pictures, which are self-contained pictures containing only I slices, can be identified as CRA pictures by encoding the NAL unit of the slices of the CRA pictures to have nal_unit_type equal to 4. Thus all coded pictures that follow the CRA picture both in decoding order and output order shall not use inter prediction from any picture that precedes the CRA picture either in decoding order or output order; and any picture that precedes the CRA picture in decoding order also precedes the CRA picture in output order.

A CRA access unit can be defined as an access unit in which the coded picture is a CRA picture. (An access unit contains a picture and may additionally contain non-picture NAL units, such as SEI or parameter set NAL units.) Hence, the CRA picture is a coded picture using intra prediction for all blocks and identifiable as random access point and for which each slice may have nal_unit_type equal to 4. All coded pictures that follow the CRA picture both in decoding order and output order shall not use inter prediction from any picture that precedes the CRA picture either in decoding order or output order; and any picture that precedes the CRA picture in decoding order also precedes the CRA picture in output order.

The table below shows NAL unit type codes and NAL unit type classes.

| nal_unit( NumBytesInNALunit ) { | Descriptor |
|---|---|
| forbidden_zero_bit | f(1) |
| nal_ref_flag | u(1) |
| nal_unit_type | u(6) |
| NumBytesInRBSP = 0 | |
| temporal_id | u(3) |
| reserved_one_5bits | u(5) |

| | | NAL |
|---|---|---|
| | | unit |
| | | type |
| nal_unit_type | Content of NAL unit and RBSP syntax structure | class |
| 0 | Unspecified | non- |
| | | VCL |
| 1 | Coded slice of a non-IDR, non-CRA and non- | VCL |
| | TLA picture slice_layer_rbsp( ) | |
| 2 | Reserved | n/a |
| 3 | Coded slice of a TLA picture | VCL |
| | slice_layer_rbsp( ) | |
| 4 | Coded slice of a CRA picture | VCL |
| | slice_layer_rbsp( ) | |
| 5 | Coded slice of an IDR picture | VCL |
| | slice_layer_rbsp( ) | |
| 6 | Supplemental enhancement information (SEI) | non- |
| | sei_rbsp( ) | VCL |
| 7 | Sequence parameter set | non- |
| | seq_parameter_set_rbsp( ) | VCL |
| 8 | Picture parameter set | non- |
| | pic_parameter_set_rbsp( ) | VCL |
| 9 | Access unit delimiter | non- |
| | access_unit_delimiter_rbsp( ) | VCL |
| 10-11 | Reserved | n/a |
| 12 | Filler data | non- |
| | filler_data_rbsp( ) | VCL |
| 13 | Reserved | n/a |
| 14 | Adaptation parameter set | non- |
| | aps_rbsp( ) | VCL |
| 15-23 | Reserved | n/a |
| 24 . . . 63 | Unspecified | non- |
| | | VCL |

Accordingly, the pictures indicated with nal_unit_type equal to 4 are referred to as a CRA picture in this specification. When the value of nal_unit_type is equal to 4 for a NAL unit containing a slice of a particular picture, all VCL NAL units of that particular picture shall have nal_unit_type equal to 4.

According to an embodiment, a parameter referred to as temporal_id or layer_id is indicative of the layer identity of the NAL unit, i.e. temporal_id specifies a temporal identifier for the NAL unit. The value of temporal_id shall be the same for all NAL units of an access unit. When an access unit contains any NAL unit with nal_unit_type equal to 4, temporal_id for all NAL units of the access unit shall be equal to 0. Also access unit containing any NAL unit with nal_unit_type equal to 5 which are identified as IDR pictures should have the temporal_id equal to 0. However, an access unit with nal unit type equal to 5 contains an IDR picture which “resets” the decoder. The IDR picture and everything that follows it in decoding order can be correctly decoded without the data that precedes the IDR picture in decoding order (i.e it does not use it for reference). Thus the differences between an IDR picture and a CRA picture are different NAL unit types, an IDR picture has POC=0, when an IDR picture is received the reference picture buffer is emptied and an IDR picture has therefore no reference picture set. Further, pictures following an IDR picture in decoding order and output order may reference pictures following the IDR picture in decoding order but is ahead in output order. That is not allowed for CRA pictures. According to the table above, when nal_unit_type is equal to 3, which implies that it is a Temporal Layer Access (TLA) picture, temporal_id shall not be equal to 0.

As mentioned above, the encoder is configured to ensure that all pictures that are encoded as CRA pictures are given layer_id =0 in order to fulfill the bitstream requirement.

The marking of pictures as “unused for prediction” may not performed before decoding the first picture following the CRA picture in decoding order and display order. Instead the marking of pictures as “unused for prediction” is performed by the decoder after decoding the first picture following the CRA picture in decoding order and display order and there is an additional rule that the first picture following the CRA picture in decoding order and display order only uses the CRA picture for reference. It should be noted that the marking is performed by both the encoder and the decoder, since the encoder has an internal decoder to keep track of what the decoder does on the bitstream that the encoder transmits.

It should also be noted that the interpretation of the NAL unit type now used for CRA pictures may be changed so that it only indicates a CRA picture if layer_id of that NAL is equal to zero. If the interpretation of the NAL unit type now used for CRA pictures is changed so that it only indicates a CRA picture if layer_id is equal to zero, the NAL unit type that is now used to define a CRA can indicate a layer switching point if its layer_id is larger than zero. In this case, a decoder shall parse both these syntax elements in order to deduce if the picture is a CRA picture or not and a decoder shall parse both these elements in order to deduce if the picture constitutes a layer switching point or not. If a decoder detects that the layer_id is not equal to 0 for a CRA picture, the decoder detects that the bitstream is not valid. The decoder can then conceal or report that the bitstream is invalid. Alternatively, the decoder may treat the picture as a non-CRA picture and continue decoding.

As an alternative a CRA indication, i.e. the NAL unit type indicates that the picture is a CRA picture, does not have a normative effect on the decoder. Instead the CRA indication is used by the encoder to indicate to a decoder or a network node that no picture following the CRA picture in decoding order and display order will use a reference picture for reference that precedes the CRA picture in coding order or display order.

It should further be noted that the encoder and the decoder can be a HEVC encoder and respective HEVC decoder but the embodiments are not limited to HEVC codecs and/or NAL units. The signaling is not limited to be done via the NAL unit header but may be done in any suitable data structure including, but not limited to, slice header, slice parameter set, picture header or picture parameter set.

In an alternative embodiment of the present invention, the video codec is a temporally layered video codec, for which layer_id above is replaced by temporal_id and the layer switching point is a temporal layer switching point.

In a further alternative embodiment of the present invention, the video codec is a multiview video codec and view_id is replacing layer_id in the description above. Correspondingly, layers are replaced by views.

Similarly, the embodiments can be applied to any layered video coding scheme, such as, but not limited to, spatial scalability, SNR scalability, bit-depth scalability and chroma format scalability, where pictures are associated with layers through syntax elements in a buffer description, the layers being ordered and having the property that a layer is ignorant of pictures belonging to a higher layer. Combination of layers mean that layer_id in the text above is replaced by a variable that is set to zero if all layered ids (e.g. temporal_id and view_id) indicate the lowest layer for that type of layer for the picture.

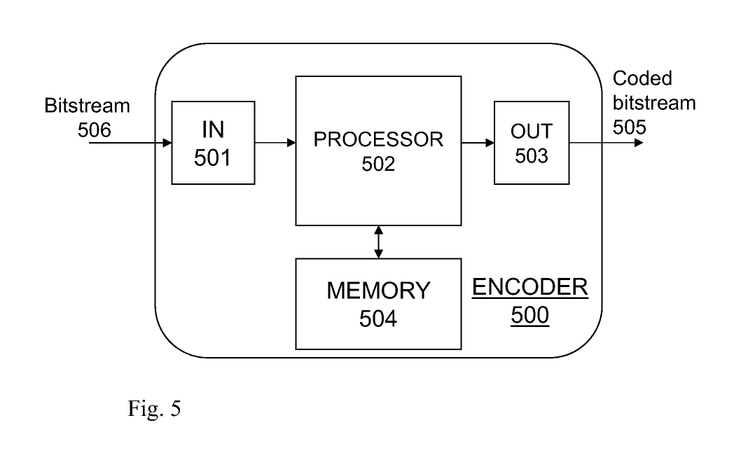

FIG. 5 illustrate an encoder 500 of e.g. video camera configured to perform the functions above.

The encoder 500 of FIG. 5 comprises an input section 501 configured to receive a bit stream 506 to be encoded. The processor 502 of the encoder is configured to assign a layer identifier to pictures being self-contained and identifiable as a type of random access point pictures (e.g. NAL unit type equal to 4) for which all coded pictures that follow that type of random access point picture both in decoding order and output order are not allowed to use inter prediction from any picture that precedes the random access point picture of said type in output order 300, a layer identifier is assigned 301 to the pictures, wherein the processor is configured to set the layer identifier to a lowest layer identity. The encoder 500 further comprises an output section 503 configured to output a coded bitstream 505. The encoder may also comprise a memory 504 storing information used in the encoding process such as information of the reference picture sets. Further, a decoder in e.g. the video camera may also be associated with the encoder, such that the encoder can keep track of what the decoder does on the bitstream that the encoder transmits.

According to an embodiment, the processor is configured to encode the pictures that are encoded with intra prediction for all blocks, i.e. self-contained, and identifiable as random access points as CRA pictures.

The encoder may be configured to output NAL units comprising slice header, NAL unit header and video payload, and information indicating if the picture is a CRA picture and to insert layer identifier information in the NAL unit header.

According to one embodiment, the encoder is a HEVC encoder and the layer identifier is a temporal identifier. According to an alternative embodiment, the encoder is a multiview encoder, wherein the layer identifier is a view identifier.

The decoder of FIG. 6 comprises an input section configured to receive the encoded bit stream to be decoded. The processor of the decoder is configured to perform the decoding functionality and an output section outputs a decoded bitstream to be displayed. The decoder may also comprise a memory storing information used in the decoding process, e.g. reference pictures.

1-14. (canceled)

15. A method of encoding pictures of a video stream, the method comprising:
assigning a layer identifier to pictures of a first type, the pictures of the first type being self-contained and identifiable as a type of random access point pictures for which all coded pictures that follow the first type both in decoding order and output order are not allowed to use inter prediction from any picture that precedes the picture of the first type; and
setting the layer identifier to a lowest layer identity.

16. The method according to claim 15, further comprising encoding the pictures of the first type as Clean Random Access (CRA) pictures.

17. The method according to claim 15, further comprising:
outputting Network Abstraction Layer (NAL) units comprising a slice header, an NAL unit header, and video payload; and
outputting information indicating if the pictures of the first type are sent in the NAL unit header.

18. The method according to claim 15, wherein the encoder comprises a HEVC encoder.

19. The method according to claim 15, wherein the layer identifier comprises a temporal identifier.

20. The method according to claim 15, wherein the encoder comprises a multiview encoder.

21. The method according to claim 20 wherein the layer identifier comprises a view identifier.

22. An encoder for encoding pictures of a video stream, the encoder comprising:
a processor configured to:
assign a layer identifier to pictures of a first type, the pictures of the first type being self-contained and identifiable as a type of random access point pictures for which all coded pictures that follow that type of random access point picture both in decoding order and output order are not allowed to use inter prediction from any picture that precedes the random picture of the first type in output order; and
set the layer identifier to a lowest layer identity.

23. The encoder according to claim 22, wherein the processor is configured to encode the pictures of the first type as Clean Random Access (CRA) pictures.

24. The encoder according to claim 22, wherein the encoder is further configured to:
output Network Abstraction Layer (NAL) units comprising a slice header, an NAL unit header, and video payload; and
include in the NAL unit header:
information indicating if the pictures are of the first type; and
layer identifier information.

25. The encoder according to claim 22, wherein the encoder comprises an HEVC encoder.

26. The encoder according to claim 22, wherein the layer identifier comprises a temporal identifier.

27. The encoder according to claim 22, wherein the encoder comprises a multiview encoder.

28. The encoder according to claim 27, wherein the layer identifier comprises a view identifier.
